(19) United States
(12) Patent Application Publication
(10) Pub. No.: US 2025/0281990 A1
(43) Pub. Date: Sep. 11, 2025

(54) SOLDERING TIP AND METHOD

(71) Applicant: PILLARHOUSE INTERNATIONAL LIMITED, Essex (GB)

(72) Inventors: Nigel MONK, Chelmsford (GB); Sam MCMASTER, Warwickshire (GB); John Edward GRAVES, Warwickshire (GB); Liang WU, Warwickshire (GB)

(73) Assignee: PILLARHOUSE INTERNATIONAL LIMITED, Essex (GB)

(21) Appl. No.: 18/285,483

(22) PCT Filed: May 25, 2022
(86) PCT No.: PCT/GB2022/051329

§ 371 Date: Oct. 3, 2023

(30) Foreign Application Priority Data
May 25, 2021 (GB) 2107447.1

(51) Int. Cl. B23K 3/02; B23K 3/06; B23K 35/02; B23K 101/42

(52) U.S. Cl. CPC B23K 3/026; B23K 3/0653; B23K 35/0222; B23K 2101/42

(57) ABSTRACT

A soldering tip for a soldering apparatus and a method of forming a soldering tip for a soldering apparatus, the tip comprising: a body formed of a first material; a proximal end for attaching the tip to the selective soldering apparatus; and a distal end, the distal end having an outer surface, at least a region of which is formed from a second material, different to the first, the second material exhibiting greater solder wettability characteristics than the first material. The first material is preferably titanium or a titanium alloy and the region is preferably formed on the first material by first using a physical vapour deposition (PVD) process to create a first coating on at least a first part of the first material, which first part underlies the region, and then coating at least a part of that first coating with the second material.

The present invention relates to a soldering tip, such as a nozzle, and a method of manufacturing the tip, and in particular a soldering tip through and/or over which molten solder can flow for soldering operations in a soldering apparatus, such as a selective soldering device or dip soldering apparatus.

A conventional soldering tip used in a typical soldering apparatus generally comprises a metal body having a “tinned” surface for allowing molten solder to flow thereover in a wetted condition, i.e. such that the molten solder readily adheres to the soldering tip. This is so that the solder flows smoothly over the tip, in full contact therewith.

The surface of a soldering tip that is readily wettable by flowing solder is typically pre-coated with solder to give it its readily-“wetting” characteristic. This coating is commonly referred to as the “tinned” surface, even though the material coating the tip is likely not pure tin. Instead, it is typically a coating of solder, which historically would have been a tin-lead solder, but now is more commonly a lead free solder, such as a tin-silver-copper solder, or a tin-silver-copper-zinc (or manganese) solder.

Other elements are also sometimes present in the solder, and can be provided specifically to alter the characteristics of the solder. Nevertheless, it is well recognised that the use of tin in the alloy that constitutes the coating on the tip provides desirable wetting characteristics to the “tinned” surface.

In a typical selective soldering apparatus, the soldering tip usually has an aperture through which the solder is pumped from a bath or reservoir of molten solder. Such soldering tips are usually referred to as soldering nozzles and they can be round with a central aperture, or other shapes, dependent upon the desired solder flow. With many of these nozzles, the solder flows over an edge or end of the aperture, which edge or end is usually at the top of the tip. Commonly, therefore, the aperture is provided as a central aperture on a substantially round nozzle as that gives directional freedom to the orientation of the nozzle.

In a selective soldering apparatus, the soldering tip is arranged to have items to be soldered dipped into the flowing solder. These are commonly known as dip-soldering devices. Often the nozzle is arranged to point directly vertically, the solder then flowing up through the aperture, and over the edge thereof—often around the full perimeter edge—to provide a uniform flow over that edge and down an outer side of the nozzle, which outer surface, and possibly the edge and some of the inner surface of the aperture—is tinned. The molten solder thus forms a bubble of solder into which the component to be soldered can be dipped, which bubble may extend around the full perimeter of the aperture: As the molten solder overflows through the aperture and down the tinned outer surface (an outer sidewall of the tip), this provides a “bubble” or radial wave of solder at the open end of the tip into which legs of electronic components can be dipped for soldering them, for example, to a PCB. These soldering apparatus types are therefore referred to a bubble soldering apparatus, or a radial wave soldering apparatus.

The provision of a tinned surface for that outer sidewall ensures the solder flow maintains a consistent contact with the outer sidewall, which then presents a regularised flow of solder over the edge of the aperture, and thus a clean and stable bubble—with a mirror-like (like a shiny ball-bearing) surface. In this manner it exhibits solder wetting characteristics, which allows a regularity of the solder flow thereover. This ensures that a soldering process can be undertaken with that soldering tip in a predictable and controlled manner. Should the wettability characteristics of the tip deteriorate, the flow uniformity of the solder from the aperture will deteriorate too, leading to a less stable, more erratic, less smooth, and thus less reliable, predictable and controlled, flow of solder over the end of the tip. That in turn leads to difficulties in using the soldering apparatus for its selective soldering applications. For example, the solder flow that would usually be regular and visually stable (the non-varying mirror finish), can become turbulent or irregular, leading to unpredictable soldering processes—for example, missed solder connections—e.g. on the PCB, or inadvertent connections (e.g. component bridging) due to solder overflow, or solder splashes.

Dross build-up around the tip will also accelerate if the wetting performance deteriorates, due to the less regular flow of the solder leading to greater solder surface area being exposed to the surrounding air, and thus higher oxidisation. This in turn leads to more frequent maintenance or cleaning of the tip, and thus longer downtime for the soldering apparatus.

Other forms of soldering apparatus may utilise an alternative solder feeding mechanism, or manual solder feeding, albeit still using molten solder that is fed onto the tip for the purpose of soldering processes.

A deterioration of the tinned surface of a soldering tip can occur due to corrosion or wear of the outer surface of the tip, for example due to a) chemical reactions between the tinned surface and the flowing hot solder, b) dissolution of the tinned surface into the flowing hot solder, or c) erosion of the tinned surface, and potentially eventually the underlying metal, due to the interaction of the outer surface with the metal alloys, or any dross, within the flowing hot solder. If dross solids are carried in the hot solder, that can significantly accelerate that corrosion or wear.

A stable and long lasting “tinned” surface is therefore a desirable characteristic for a soldering tip. However, the wearable nature of tinned surfaces is well known in the soldering industry, and soldering tips are thus a user-replaceable item. They can also, in some instances, be a serviceable item, as some tips can be re-tinned or resurfaced to reinstate the desired wetting performance. A soldering tip which is made from a material which does not need initial “tinning”, and is stable, long lasting and readily wettable with molten solder, is very desirable as it would reduce costs associated with the manufacture, installation and maintenance of a soldering tip.

The present invention seeks to provide a soldering tip which will tend to wear less, and which will thus have a longer service life, and one that is readily wettable with molten solder, or readily tinnable for uniformly receiving molten solder thereafter.

According to a first aspect of the present invention there is provided a soldering tip for a soldering apparatus, the tip comprising:
a body formed of a first material and having a proximal end for attaching the tip to the soldering apparatus; and
the tip also comprises an outer surface, at least a region of which is formed from a steel alloy, the steel alloy not exceeding 2 wt % carbon and 5 wt % chromium.

In some embodiments the first material and the outer surface are one and the same material.

In some embodiments the first material is also a steel alloy, and does not exceed 2 wt % carbon and 5 wt % chromium.

In some embodiments the or each steel alloy does not exceed 2% chromium and more preferably 1% chromium. Percentages are wt %.

In some embodiments it is preferred that the iron content by weight of the or each steel alloy be at least 90%, and more preferably 92% or greater, and most preferably more than 95% or more than 97%.

In some embodiments the or each steel alloy has the following composition: 0.5 to 2% carbon, 0.1% to 5% chromium, 0.1 to 1% manganese, 0 to 1% silicon, 0 to 0.5% vanadium, 0 to 0.3% phosphorus, 0 to 0.3% sulphur, and ideally the whole balance in iron. Percentages are wt %.

In some embodiments the or each steel alloy has the following composition: 0.95 to 1.25% carbon, 0.35% to 0.8% chromium, 0.2 to 0.45% manganese, 0 to 0.4% silicon, 0 to 0.12% vanadium, 0 to 0.045% phosphorus, 0 to 0.045% sulphur, and ideally the whole balance in iron. Percentages are wt %.

In some embodiments the or each steel alloy has the following composition: 0.420 to 0.50% carbon, 0.60 to 0.90% manganese, 0 to 0.040% phosphorous, 0 to 0.050% sulphur.

In some embodiments the or each steel alloy additionally has the following composition options: 0 to 0.4% silicon, 0 to 0.4% nickel, 0 to 0.4% chromium, and ideally the whole balance in iron. Typically the iron balance is 98.51 to 98.98%. Percentages are wt %.

In some embodiments the or each steel alloy has the following composition: 0.90 to 1.10% carbon, 0.25 to 0.70% manganese, 0 to 0.030% phosphorous, 0 to 0.025% sulphur, 0.10 to 0.35% silicon, 1.2 to 1.65% chromium.

In some embodiments the or each steel alloy additionally has the following composition options: 0 to 0.3% nickel, 0 to 0.30% copper, 0 to 0.10% molybdenum, and ideally the whole balance in iron. Typically the iron balance is 96.5 to 97.32%. Percentages are wt %.

In some embodiments the or each steel alloy has the following composition: 0.10% carbon, 1.0% manganese, 0.040% phosphorous, 0.030% sulphur, 1.0% silicon, 4.0 to 5.0% chromium, 0.40 to 0.65% molybdenum, and ideally the whole balance in iron. Percentages are wt %. In some embodiments the iron content by weight is 93%.

In some embodiments the or each steel alloy has one or more of the following composition options:
a) carbon in the amount by weight percent: 0.10 to 1.10%, 0.42 to 0.50%, 0.43 to 0.50%, 0.42 to 0.48%, 0.980 to 1.10%, 0.93 to 1.05%, 0.90 to 1.05%, 0.95 to 1.10%, or about 0.10%;
b) manganese in the amount by weight percent: 0.25 to 1.0%, 0.60 to 0.90%, 0.50 to 0.80%, 0.250 to 0.450%, 0.25 to 0.45, about 0.50%, 0.40 to 0.70% or about 1.0%;
c) phosphorous in the amount by weight percent: 0%, 50.040%, about 0.04%, about 0.03%, 50.0250%, about 0.025%, about 0.030% or about 0.040%;
d) sulphur in the amount by weight percent: 0%, 50.050%, about 0.050%, about 0.035%, 50.0250%, about 0.015%, about 0.025% or about 0.030%;
e) silicon in the amount by weight percentage: 0%, 0 to 1.0%, about 0.4%, 0.15 to 0.35%, 0.150 to 0.300%, 0.10 to 0.35% or 1.0%;
f) nickel in the amount by weight percentage: 0%, 0 to 0.4%, about 0.4%, about 0.25% or about 0.30%;
g) chromium in the amount by weight percent: 0%, 0 to 5%, about 0.4%, 1.30 to 1.60%, 1.35 to 1.60%, 1.35 to 1.65%, 1.20 to 1.60% or 4.0 to 5.0%;
h) copper in the amount by weight percent: 0%, 0 to 0.30% or about 0.30%; or
i) molybdenum in the amount by weight percent: 0%, 0 to 0.65%, about 0.10% or 0.40 to 0.65%.

Ideally the whole balance of the weight percentage is then in iron.

Typically the iron content by weight is 93% to 98.98%, 98.51 to 98.98%, 96.5 to 97.32% or about 93%.

Percentages are wt %.

In some embodiments the steel alloy is silver steel meeting British Standard BS-1407, or more specifically BS ISO 1407:1970.

In some embodiments the steel alloy is silver steel meeting European/Werkstoff Standard 1.2210/115CrV3.

In some embodiments the or each steel alloy is C45 steel meeting European Standard EN 10083-2 with a grade of C45/1.1191.

In some embodiments the or each steel alloy is C45 steel meeting United States Standard AISI 1045.

In some embodiments the or each steel alloy is C45 steel meeting United States Standard ASTM A29 with a grade of 1045.

In some embodiments the or each steel alloy is C45 steel meeting Japanese Industrial Standard JIS G4051 with a grade S45C.

In some embodiments the or each steel alloy is EN31 steel meeting British Standard BS 970 with a grade of 535A99/EN31.

In some embodiments the or each steel alloy is EN31 steel meeting United States Standard AISI 52100.

In some embodiments the or each steel alloy is EN31 steel meeting United States Standard ASTM A295 with a grade of 52100.

In some embodiments the or each steel alloy is EN31 steel meeting Japanese Industrial Standard JIS G4805 with a grade SUJ2.

In some embodiments the or each steel alloy is EN31 steel meeting German Standard DIN 17230 with a grade 100Cr6/1.3505.

In some embodiments the steel alloy is 501 stainless steel meeting any one of United States Standards AISI 501, ASTM A295; ASTM A193; ASTM A194; ASTM A314; ASTM A387 (5); ASTM A473; ASTM A182 (B5, F7); ASTM A193 (501, B5); ASTM A194 (501, 3); AISI 501; ASME SA194 (Type 3); ASME SA387 (Type 5); AMS 5502; AMS 5602; UNS S50100 and SAE J405 (51501).

In some embodiments the steel alloy is 501 stainless steel meeting German Standard DIN 1.7362.

In some embodiments the steel alloy is nitrided. This can provide extra hardness to the material to increase its wear resistance and thus its service life. In some embodiments the nitriding is a nitriding of the outer surface, which outer surface may be an outer surface of a distal part of the body.

Nitriding can be performed by a process known as gas nitriding. The process of gas nitriding can be performed on steel alloys by the following process, which may take 36 hours at 520° C. Firstly, the parts of steel alloy to be nitrided are placed into a pressurised vessel which is substantially vacated of air. Ammonia is then circulated around the chamber which diffuses into the surface creating a compound layer with a diffusion layer below. In some embodiments the compound layer is known as a white layer. In some embodiments the steel alloy to be nitrided is silver steel. However, it may be another form of steel alloy falling within the scope of the invention, such as those discussed above.

For silver steel, the compound layer of the nitrided silver steel may have the following properties: surface hardness of about 3,442 GPa and a core hardness of about 2.197 GPa. The compound layer may be about 8 microns thick.

In some embodiments the steel alloy at the outer surface is hardened. This can provide increased wear resistance and an increased service life to the soldering tips described in the present invention.

In accordance with a further aspect of the present invention there can be provided a method of manufacturing a soldering tip for a soldering apparatus, comprising forming a soldering tip with a body having a proximal end for attaching the tip to the soldering apparatus and an outer surface, at least a region of the outer surface being formed from a steel alloy, the steel alloy not exceeding 2 wt % carbon and 6 wt % chromium, and performing a hardening process thereto to harden at least a part of the surfaces thereof that will contact molten solder during use of the soldering tip.

In some embodiments the hardening is by way of nitriding.

In some embodiments the steel alloy is hardened by the following steps:
i) heating the soldering tip to 760-800° C.;
ii) allowing the soldering tip to austentized at least until the temperature is uniform; and
iii) quenching the soldering tip in water.

In some embodiments the steel alloy is hardened by the following steps:
i) annealing the soldering tip by heating the soldering tip to 800-850° C.;
ii) cooling the soldering tip in a furnace;
iii) normalising the soldering tip by heating the soldering tip to 870-920° C.;
iv) soaking the soldering tip in water, brine or oil for 10-15 minutes;
v) cooling the soldering tip in air;
vi) stress-relieving the soldering tip by heating the soldering tip to 550-600° C.;
vii) soaking the soldering tip in water, brine or oil for 1 hour per 25 mm of section;
viii) cooling the soldering tip in air;
ix) hardening the soldering tip by heating the soldering tip to 820-850° C.;
x) quenching and soaking the soldering tip in water, brine or oil for 10-15 minutes per 25 mm of section;
xi) tempering the soldering tip by reheating it to a temperature in a range from 400 to 650° C.;
xii) soaking the soldering tip in water, brine or oil for 1 hour per 25 mm of section; and
xiii) cooling the soldering tip in air.

In some embodiments the steel alloy is hardened by the following steps:
i) Hardening the soldering tip by cold working, or heating and quenching steps;
ii) heating the soldering tip to 788° C.;
iii) quenching the soldering tip;
iv) carburizing the soldering tip at 913° C.; and
v) further quenching the soldering tip.

In some embodiments the steel alloy is hardened by the following steps:
i) annealing the soldering tip by heating the soldering tip to 829 to 871° C.;
ii) gradually furnace cooling the soldering tip;
iii) providing a further annealing step to the soldering tip by heating the soldering tip to 718 to 746° C.;
iv) gradually cooling the soldering tip;
v) hardening the soldering tip by heating it to 871 to 927° C.;
vi) soaking, oil quenching and then tempering at 204 to 760° C.

The above steel alloys or hardened steel alloys have been noted by the applicant to be metallophillic to molten solder and thus provide a wettable (commonly referred to as “tinned”) surface for the soldering tip, while having a significantly improved service life compared to tips that have been tinned with solder.

The above steel alloys or hardened steel alloys may form the entirety of the soldering tip. This is because they are metallophilic to solder and thus provide a wettable surface for the soldering tip, while also being suitable for attachment to the soldering apparatus, and while having a significantly improved service life compared to conventional tips that have been tinned with solder. They achieve this by having an improved (higher) resistance to chemical and/or mechanical wear.

In some embodiments the first material is also such a steel alloy or hardened steel alloy. In some embodiments the tip is made of a single material which may be a steel alloy as detailed above. However, it is preferred that the first material is titanium or a titanium alloy and that the steel alloy or hardened steel alloy is formed on or joined to the first material. The steel alloy or hardened steel alloy, when being a second material different to the first, is chosen as it can exhibit greater solder wettability characteristics than the first material—titanium and titanium alloys have a metallophobic characteristic with respect to most, if not all, solders, and as such is not wettable within the context of the present invention.

In some embodiments the first material is grade 2 titanium or another corrosion resistant alloy. By being corrosion resistant, it will withstand the environment of the soldering apparatus—with hot solder flowing over (and usually through) it. However, many corrosion resistant materials are metallophobic to solder—i.e. solder does not wet to it. Titanium and its alloys have the additional benefit of excellent long term wear resistance, even when exposed to a continuous flow of molten solder.

In some embodiments the region of the outer surface that is formed from the steel alloy extends around the full perimeter of a distal end of the soldering tip.

In some embodiments the steel alloy is a coating on the first material. It may be directly coating the first material or it may coat it via one or more intermediate adhesion layer.

In some embodiments the first material is a steel alloy or hardened steel alloy which is the same material as the second material, therefore providing a soldering tip made of one material.

The or each adhesion layer may be formed on or deposited on the first material, or a subsequently formed or deposited preceding adhesion layer, and the steel alloy may then be formed on or deposited on the final of those adhesion layers.

In some embodiments the body extends substantially the full length of the soldering tip, with the steel alloy and any adhesion layer being just a coating thereon. However, the soldering tip may instead have a second component for forming a distal end of the soldering tip, which second component may be formed separately and then attached to the body. Alternatively it might be formed into or onto the body. For example, the distal end may be formed on an end piece that is attached into or onto the body. It may be screwed or otherwise interlocked thereon (or therein) or fitted via an interference fit, for example.

In some embodiments the first material forms a base material, and a first coating material (or adhesion layer) provides at least a partial coating over the base material onto which the steel alloy can then be formed or provided. For this purpose the first coating material is preferably chosen to be receptive to further coating with the steel alloy.

In some embodiments the first coating material—which may be referred to as an adhesion coating or an adhesion layer—can be for facilitating electrodeposition (for example) of the steel alloy thereon. For example, the steel alloy may be applied by physical vapour deposition (PVD). This is a vacuum plasma deposition process allowing the deposition of various metals and ceramics onto a potentially non-conventionally receptive underlayer. Coatings provided in this manner may be sufficiently hard and wear resistant to provide an improvement over conventional nozzles.

PVD is a line-of-sight process and as such complex geometries are difficult to coat. It has thus not been used for soldering nozzles as there are usually internal flow passageways for the solder to flow through. However, the inventors have appreciated that due to the usually simple geometry of the area of the nozzle that needs to wet—usually a frustoconical outer surface surrounding the distal end of the soldering tip, or a segment thereof, an apex circumference of the aperture—often ring shaped, or a part thereof—often planar, or one or more slopped sides or outer regions of the nozzle—often arcuate or planar, these being collectively or individually commonly referred to as magnetron sputtering targets for the PVD coating system, PVD can be used just to selectively coat the required parts of a nozzle, and PVD coating systems will usually be able to selectively coat those wettability (metallaphillic) regions using the PVD technique.

With PVD, the properties of the coatings are affected by the substrate they are deposited on, the temperature of the ions reaching the substrate in relation to the melting point of the substrate (known as the homologous temperature) and the pressure of the gas flow in the chamber. These parameters affect the energy of the ions that assemble to form the coating. As a result the method can provide a wide range of possible coatings.

In some embodiments this coating should be electrically conductive to allow for other coatings to be deposited using electrodeposition. However in some embodiments the steel alloy may be coated onto the “adhesion coating” using electroless deposition, making the underlying layer not be required to be electrically conductive.

In some embodiments the first coating material comprises one or more of tungsten carbide, titanium carbide and titanium nitride.

In some embodiments the soldering tip is a nozzle with a through-hole for solder to flow through it.

In some embodiments the through-hole is a central aperture through the length of the nozzle.

In some embodiments the distal end is formed to surround the solder outflow end of the aperture. In some embodiments the distal end and the body are formed as separate components and are joined together, preferably with the aperture being a continuous aperture extending through both the body and the distal end of the soldering tip.

In some embodiments the body has a threaded proximal end for attachment of the soldering tip to the soldering apparatus.

In some embodiments the soldering tip is a 6 mm diameter “all purpose” (“AP”) nozzle, suitable for use for either or both of dip and draw soldering. As discussed above, dip soldering involves dipping legs or parts of components to be soldered into the bubble—by moving either or both of the nozzle and the component to be soldered, whereas draw soldering involves drawing the bubble across one or more legs or parts of components to be soldered, by moving either or both the nozzle and the component to be soldered.

According to a further aspect of the present invention there is provided a soldering tip for a soldering apparatus, the tip comprising:
a body having a proximal end for attaching the tip to the soldering apparatus; and
an outer surface, at least a region of which is formed from a steel alloy, the steel alloy not exceeding 2 wt % carbon and 6 wt % chromium.

In some embodiments the body is also a steel alloy, and does not exceed 2 wt % carbon and 5 wt % chromium. For example, the body and the outer surface may be unitary, both being formed from the same steel alloy.

The or each steel alloy may be in accordance with any of the preceding aspects, although in some embodiments the wt % range for chromium extends up to 6% in weight—in some embodiments this may be, for example 0%, about 0.4%, 1.30 to 1.60%, 1.35 to 1.60%, 1.35 to 1.65%, 1.20 to 1.60% or 4.0 to 6.0%. Again, the material may be a hardened steel alloy.

According to a further aspect of the present invention there is provided a method of forming a soldering tip for a soldering apparatus, the tip comprising:
a body formed of a first material;
a proximal end for attaching the tip to the selective soldering apparatus; and
a distal end, the distal end having an outer surface, at least a region of which is formed from a second material, different to the first, the second material exhibiting greater solder wettability characteristics than the first material;
wherein the method is characterised in that:
the first material is titanium or a titanium alloy; and
the region is formed on the first material by first using a physical vapour deposition (PVD) process to create a first coating on at least a first part of the first material, which first part underlies the region, and then coating at least a part of that first coating with the second material.

With this method, the first material (titanium or titanium alloy), which is generally difficult to coat with solder due to its metallophobic characteristics, can have a first coating applied thereto (using the PVD), which first coating can provide a material that is more receptive to tinning than the first material. Then that first coating can be tinned or coated with the second material. This then allows the highly wear resistant titanium (or titanium alloy) to be used for the base material of the tip, while still allowing the tip to be tinned.

In one embodiment, the first coating is coated, for example, by electrically coating it (using electroplating or electrodeposition, for example) with a metal or ceramic that can be wetted—i.e. a metallophillic material. The electrical coating could even be done using techniques such as electrophoretic or underpotential deposition.

In some embodiments the soldering tip is in accordance with the first aspect of the present invention.

In some embodiments the tip has a through-hole such that in use, solder flow from the soldering apparatus can flow up and through the soldering tip from a molten solder reservoir of the soldering apparatus.

In some embodiments, the wettable coating on the tip has at least a region formed from a steel alloy, the steel alloy not exceeding 2 wt % carbon and 5 wt % chromium. In some embodiments this may instead be up to 6 wt % chromium.

In some embodiments it is preferred that the iron content of the steel alloy be at least 90%, and more preferably 92% or greater, and most preferably more than 95% or more than 97%.

In some embodiments the steel alloy does not exceed 2% chromium and more preferably it does not exceed 1% chromium. Percentages are wt %.

In some embodiments the steel alloy has the following composition: 0.5 to 2% carbon, 0.1% to 5% chromium, 0.1 to 1% manganese, 0 to 1% silicon, 0 to 0.5% vanadium, 0 to 0.3% phosphorus, 0 to 0.3% sulphur, and the balance in iron. Percentages are wt %.

In some embodiments the second material is a steel alloy, the steel alloy having the following composition: 0.95 to 1.25% carbon, 0.35% to 0.8% chromium, 0.2 to 0.45% manganese, 0 to 0.4% silicon, 0 to 0.12% vanadium, 0 to 0.045% phosphorus, 0 to 0.045% sulphur, and the balance in iron. Percentages are wt %.

In some embodiments the second material is a steel alloy, the steel alloy having the following composition: 0.420 to 0.50% carbon, 0.60 to 0.90% manganese, 0 to 0.040% phosphorous, 0 to 0.050% sulphur.

In some embodiments the second material is a steel alloy, the steel alloy having the following composition options: 0 to 0.4% silicon, 0 to 0.4% nickel, 0 to 0.4% chromium, and ideally the whole balance in iron. Typically the iron balance is 98.51 to 98.98%. Percentages are wt %.

In some embodiments the second material is a steel alloy, the steel alloy having the following composition: 0.90 to 1.10% carbon, 0.25 to 0.70% manganese, 0 to 0.030% phosphorous, 0 to 0.025% sulphur, 0.10 to 0.35% silicon, 1.2 to 1.65% chromium.

In some embodiments the second material is a steel alloy, the steel alloy having the following composition options: 0 to 0.3% nickel, 0 to 0.30% copper, 0 to 0.10% molybdenum, and ideally the whole balance in iron. Typically the iron balance is 96.5 to 97.32%. Percentages are wt %.

In some embodiments the second material is a steel alloy, the steel alloy having the following composition: 0.10% carbon, 1.0% manganese, 0.040% phosphorous, 0.030% sulphur, 1.0% silicon, 4.0 to 6.0% chromium, 0.40 to 0.65% molybdenum, and ideally the whole balance in iron. Percentages are wt %. In some embodiments the iron content by weight is 93%.

In some embodiments the second material is a steel alloy, the steel alloy having one or more of the following composition options:
a) carbon in the amount by weight percent: 0.10 to 1.10%, 0.42 to 0.50%, 0.43 to 0.50%, 0.42 to 0.48%, 0.980 to 1.10%, 0.93 to 1.05%, 0.90 to 1.05%, 0.95 to 1.10%, or about 0.10%;
b) manganese in the amount by weight percent: 0.25 to 1.0%, 0.60 to 0.90%, 0.50 to 0.80%, 0.250 to 0.450%, 0.25 to 0.45, about 0.50%, 0.40 to 0.70% or about 1.0%;
c) phosphorous in the amount by weight percent: 0%, 50.040%, about 0.04%, about 0.03%, 50.0250%, about 0.025%, about 0.030% or about 0.040%;
d) sulphur in the amount by weight percent: 0%, 50.050%, about 0.050%, about 0.035%, 50.0250%, about 0.015%, about 0.025% or about 0.030%;
e) silicon in the amount by weight percentage: 0%, 0 to 1.0%, about 0.4%, 0.15 to 0.35%, 0.150 to 0.300%, 0.10 to 0.35% or 1.0%;
f) nickel in the amount by weight percentage: 0%, 0 to 0.4%, about 0.4%, about 0.25% or about 0.30%;
g) chromium in the amount by weight percent: 0%, 0 to 6%, about 0.4%, 1.30 to 1.60%, 1.35 to 1.60%, 1.35 to 1.65%, 1.20 to 1.60% or 4.0 to 6.0%;
h) copper in the amount by weight percent: 0%, 0 to 0.30% or about 0.30%; or
i) molybdenum in the amount by weight percent: 0%, 0 to 0.65%, about 0.10% or 0.40 to 0.65%.

Ideally the whole balance of the weight percentage is then in iron.

Typically the iron content by weight is 93% to 98.98%, 98.51 to 98.98%, 96.5 to 97.32% or about 93%.

Percentages are wt %.

In some embodiments the steel alloy is silver steel meeting British Standard BS-1407 or more specifically BS ISO 1407:1970.

In some embodiments the steel alloy is silver steel meeting European/Werkstoff Standard 1.2210/115CrV3.

In some embodiments the steel alloy is C45 steel meeting European Standard EN 10083-2 with a grade of C45/1.1191.

In some embodiments the steel alloy is C45 steel meeting United States Standard AISI 1045.

In some embodiments the steel alloy is C45 steel meeting United States Standard ASTM A29 with a grade of 1045.

In some embodiments the steel alloy is C45 steel meeting Japanese Industrial Standard JIS G4051 with a grade S45C.

In some embodiments the steel alloy is EN31 steel meeting British Standard BS 970 with a grade of 535a99/EN31.

In some embodiments the steel alloy is EN31 steel meeting United States Standard AISI 52100.

In some embodiments the steel alloy is EN31 steel meeting United States Standard ASTM A295 with a grade of 52100.

In some embodiments the steel alloy is EN31 steel meeting Japanese Industrial Standard JIS G4805 with a grade SUJ2.

In some embodiments the steel alloy is EN31 steel meeting German Standard DIN 17230 with a grade 100Cr6/1.3505.

In some embodiments the steel alloy is 501 stainless steel meeting any one of United States Standards AISI 501, ASTM A295; ASTM A193; ASTM A194; ASTM A314; ASTM A387 (5); ASTM A473; ASTM A182 (B5, F7); ASTM A193 (501, B5); ASTM A194 (501, 3); AISI 501; ASME SA194 (Type 3); ASME SA387 (Type 5); AMS 5502; AMS 5602; UNS S50100 and SAE J405 (51501).

In some embodiments the steel alloy is 501 stainless steel meeting German Standard DIN 1.7362.

In some embodiments the steel alloy is nitrided. This can provide extra hardness to the material to increase its wear resistance and thus its service life.

Nitriding can be performed by a process known as gas nitriding. The process of gas nitriding can be performed on steel alloys by the following process, which may take 36 hours at 520° C. Firstly, the parts of steel alloy to be nitrided are placed into a pressurised vessel which is substantially vacated of air. Ammonia is then circulated around the chamber which diffuses into the surface creating a compound layer with a diffusion layer below. In some embodiments the compound layer is known as a white layer. In some embodiments the steel alloy to be nitride is silver steel. However, it may be another form of steel alloy falling within the scope of the invention, such as those discussed above.

For silver steel, the compound layer of the nitrided silver steel may have the following properties: surface hardness of about 3,442 GPa and a core hardness of about 2.197 GPa. The compound layer may be about 8 microns thick.

In some embodiments the steel alloy is hardened. This can provide increased wear resistance and an increased service life to the soldering tips described in the present invention. The hardening process may be in accordance with the previously described processes, or as described below.

The present invention also provides a soldering apparatus comprising one or more soldering tip as defined above.

Preferably the soldering apparatus is a selective soldering apparatus. It may be a dip soldering apparatus allowing components to be soldered to have their legs dipped into a bubble, a wave (radial or lateral) or a jet (or arch) of molten solder on, above or around, or flowing out of, the soldering tip.

Although commonly circular in section, the soldering tip can instead be configured in other shapes too, such as to have an elongated through-hole, or a rectangular or custom-shaped section.

These and other features of the present invention will now be described in further detail, purely by way of example, with reference to the accompanying drawings, in which:

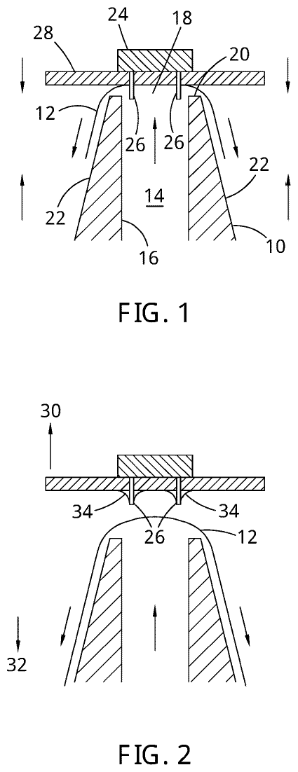

FIG. 1 schematically shows two legs of an electrical component being soldered to the underside of a PCB using a schematically illustrated soldering tip, in the form of a generic solder-bubble nozzle;

FIG. 2 schematically shows those legs correctly soldered, and a solder bubble at the top of the nozzle;

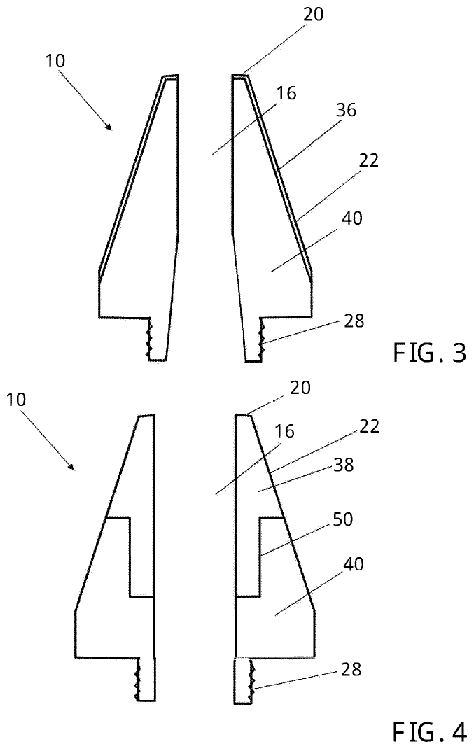

FIG. 3 schematically shows a first form of a soldering tip according to the present invention; and

FIG. 4 schematically shows a further form of a soldering tip according to the present invention.

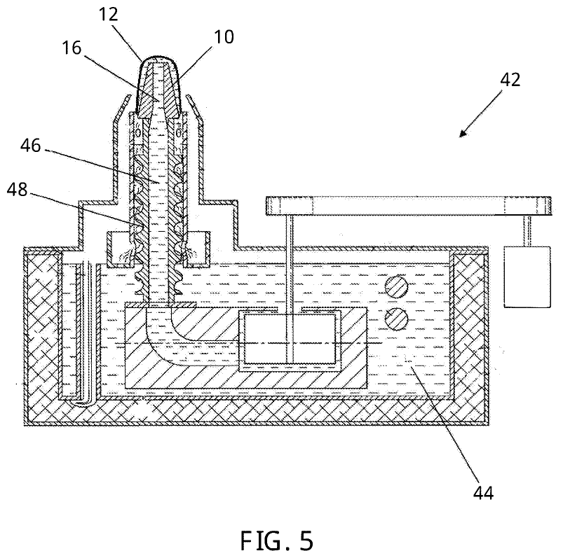

FIG. 5 schematically shows a soldering apparatus including a soldering tip according to the present invention.

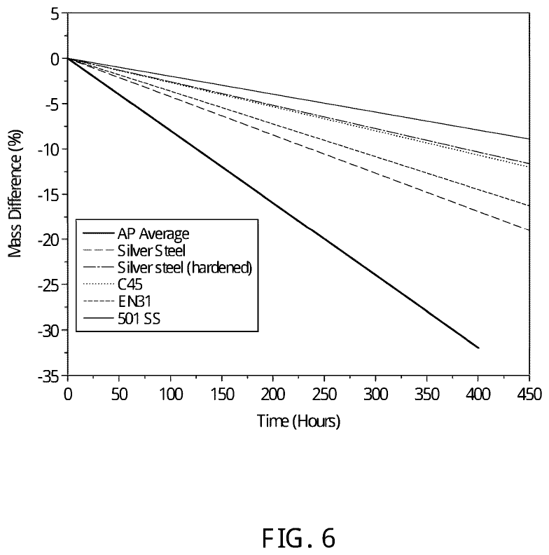

FIG. 6 shows a graph illustrating wear as a mass difference (mass loss on the nozzle) against time for different steel alloys versus a conventional AP nozzle average wear characteristic.

Referring FIGS. 1 and 2, there is schematically shown a soldering process using a generic soldering tip 10. In this illustrated example, the tip 10 is a round nozzle (round section when viewed from above) with a central channel or through-hole 16 extending through it. Thus it produces a generally rounded (at the top) bubble 12, i.e. a radial wave, of molten solder 14 at the top (distal end 20) thereof (rounded as viewed from above and to the side) when molten solder from a bath or reservoir (not shown) of the soldering apparatus is pumped up and out through the through-hole 16. This rounded bubble 12 has a generally curved outer surface as the solder 14 that forms it exits the through-hole 16 and overflows the distal end to return to the bath of the soldering apparatus. See FIG. 2 for an uninterrupted view of the bubble 12.

As solder 14 flows upwardly through the central channel or through-hole 16 of the soldering tip or nozzle 10, it approaches the distal end 20 at the top of the nozzle 10 and the solder 14 then overflows the distal end 20 at the top of the nozzle 10 for overflowing down the outer surface 22 of the nozzle 10.

Other forms or types of solder tip are also known in the art, including jet, wave and custom designs, and some instead have a side-port for the solder to overflow through, or non-circular sections. All of these can be accommodated by the present invention.

With the bubble 12 or radial wave of molten solder, as shown in FIG. 1, an electrical component 24 can be soldered to a PCB 28. In this example, the electrical component having two legs 26—this could instead be one or more than two legs, and they are arranged for dipping into the solder bubble 12—in FIG. 1 they are already dipped. This dipping is done so that the legs can be soldered by the solder bubble 12 to the printed circuit board (PCB) 28, through which the legs (in this example) extend.

The PCB 28 and the electrical component 24 are positioned above the bubble or radial wave and get dropped and then lifted out of the solder (or the bubble is raised and dropped) to achieve the dipping of the legs in the solder flow (the bubble 12) and thus also the completion of the soldering process. A similar dipping is likewise carried out with wave or jet soldering machines, albeit with the bubble instead being differently arranged as a wave or jet as it exits the tip.

Once soldered, the legs are connected to the PCB for functioning in their conventional manner.

In order for this soldering process to be repeatable and uniform, the uniformity of the bubble or radial wave (or linear/lateral wave or jet) is important. For example, irregularities in the flow of solder in the bubble (or wave or jet) can lead to imperfect solder joints. These irregularities can be ripples in the bubble (or wave or jet), or in the worst case, either dewetting of the nozzle or dross flowing within the solder flow. Good wetting of the tip (adhesion of the solder flow to the outer surface of the soldering tip) helps to avoid dewetting (de-adhesion of the solder flow from the outer surface) and dross formation—dross formation is commonly accelerated upon commencement of dewetting.

Common causes for the commencement or encouragement of these imperfections include situations where the wettable surface of the nozzle, or the nozzle itself—e.g. in the through-hole—wears away, which can lead to freezing or jetting of the solder flow, or an increased build up of dross in the solder flow in, on or around the nozzle.

With the present invention, the standard tinned tip (in which the tip is typically pre-coated with solder material) is replaced with a new design of soldering tip.

As shown in FIG. 3 a first form of soldering tip 10 is illustrated in which the tip 10 comprises a body 40 formed of a first material—herein titanium or a titanium alloy, and it has a proximal end 28 for attaching the tip 10 to a soldering apparatus 42. See, for example, FIG. 5. For this purpose, this example has a threaded proximal end 28. It is also shown to have a tapering internal aperture 16, as also shown in FIG. 5, to allow molten solder 14 to be pumped up through a delivery tube 48 from a reservoir or tank 44 to the soldering tip 10 through a smooth walled passageway 46 from the reservoir or tank 44 of the soldering apparatus 42. The absence of steps in the passageway 46 avoids areas where the molten solder can stagnate. Instead, therefore, the passageway 46 connects to the through-hole 16, through the soldering tip 10, with a smooth transition.

In FIG. 4, instead a wider through-hole 16 is provided.

The soldering tip 10 in FIG. 3 (and likewise in FIG. 4) also comprises a distal end 20 over which the solder can flow to form a bubble 12 of molten solder—like that shown in FIG. 2, and as also shown in FIG. 5.

The soldering tip 10 also has an outer surface 22, at least a region of which is formed from a steel alloy. In this embodiment, the steel alloy is a coating 36 on the body 40. FIG. 4 has a different configuration.

The steel alloy is provided to enable molten alloy to wet the outer surface 22 of the soldering tip 10. It is needed as titanium and titanium alloys are generally metallophobic, whereby they don't readily wet by molten solder. It is believed that this is because the titanium rapidly forms an oxide coating and the solder will not readily adhere to the oxide. The steel alloy is chosen, therefore, to have a greater affinity for wetting by solder than the surface on the titanium. Preferred steel alloys for this purpose do not exceed 2 wt % carbon and 5 wt % chromium in their composition. The reduced chromium compared to stainless steel tends to achieve a higher percentage of iron in the alloy, and this is understood to encourage solder adhesion.

In some embodiments as much as 6% chromium may be provided.

In some embodiments it is preferred that the iron content of the steel alloy be at least 90%, and more preferably 92% or greater, and most preferably more than 95% or more than 97%. These percentages are also wt %.

In typical stainless steels there is at least 10% chromium, plus lower percentages of various other elements too, including carbon. These stainless steel alloys have mostly been found not to be suitable.

In some embodiments the steel alloy does not exceed 2% chromium and more preferably it does not exceed 1% chromium. These percentages are also wt %.

The inventors have noted that particularly beneficial wetting characteristics are exhibited by the steel alloys that have the following composition: 0.5 to 2% carbon, 0.1% to 5% chromium, 0.1 to 1% manganese, 0 to 1% silicon, 0 to 0.5% vanadium, 0 to 0.3% phosphorus, 0 to 0.3% sulphur, and the balance in iron, or more preferably 0.95 to 1.25% carbon, 0.35% to 0.8% chromium, 0.2 to 0.45% manganese, 0 to 0.4% silicon, 0 to 0.12% vanadium, 0 to 0.045% phosphorus, 0 to 0.045% sulphur, and the balance in iron. These latter percentages are able to be met by a steel alloy known as silver steel that meets British Standard BS-1407 or more specifically BS ISO 1407:1970. Likewise they are able to be met by silver steel meeting the equivalent European/Werkstoff Standard 1.2210/115CrV3.

The inventors have also noted better wear resistance from such steel alloys.

Likewise, the inventors have noted that particularly beneficial wetting and wear resistance characteristics are exhibited by the steel alloys that have the following composition: 0.420 to 0.50% carbon, 0.60 to 0.90% manganese, 0 to 0.040% phosphorous, 0 to 0.050% sulphur.

Likewise, the inventors have noted that particularly beneficial wetting and wear resistance characteristics are exhibited by the steel alloys that additionally have the following composition options: 0 to 0.4% silicon, 0 to 0.4% nickel, 0 to 0.4% chromium, and ideally the whole balance in iron. Typically the iron balance is 98.51 to 98.98%. Percentages are wt %.

Likewise, the inventors have noted that particularly beneficial wetting and wear resistance characteristics are exhibited by the steel alloys that have the following composition: 0.90 to 1.10% carbon, 0.25 to 0.70% manganese, 0 to 0.030% phosphorous, 0 to 0.025% sulphur, 0.10 to 0.35% silicon, 1.2 to 1.65% chromium.

Likewise, the inventors have noted that particularly beneficial wetting and wear resistance characteristics are exhibited by the steel alloys that additionally have the following composition options: 0 to 0.3% nickel, 0 to 0.30% copper, 0 to 0.10% molybdenum, and ideally the whole balance in iron. Typically the iron balance is 96.5 to 97.32%. Percentages are wt %.

Likewise, the inventors have noted that particularly beneficial wetting and wear resistance characteristics are exhibited by the steel alloys that have the following composition: 0.10% carbon, 1.0% manganese, 0.040% phosphorous, 0.030% sulphur, 1.0% silicon, 4.0 to 5.0% (or up to 6%) chromium, 0.40 to 0.65% molybdenum, and ideally the whole balance in iron. Percentages are wt %. In some embodiments the iron content by weight is 93%.

Likewise, the inventors have noted that particularly beneficial wetting and wear resistance characteristics are exhibited by the steel alloys that additionally have the following composition options:
a) carbon in the amount by weight percent: 0.10 to 1.10%, 0.42 to 0.50%, 0.43 to 0.50%, 0.42 to 0.48%, 0.980 to 1.10%, 0.93 to 1.05%, 0.90 to 1.05%, 0.95 to 1.10%, or about 0.10%;
b) manganese in the amount by weight percent: 0.25 to 1.0%, 0.60 to 0.90%, 0.50 to 0.80%, 0.250 to 0.450%, 0.25 to 0.45, about 0.50%, 0.40 to 0.70% or about 1.0%;
c) phosphorous in the amount by weight percent: 0%, 50.040%, about 0.04%, about 0.03%, 50.0250%, about 0.025%, about 0.030% or about 0.040%;
d) sulphur in the amount by weight percent: 0%, 50.050%, about 0.050%, about 0.035%, 50.0250%, about 0.015%, about 0.025% or about 0.030%;
e) silicon in the amount by weight percentage: 0%, 0 to 1.0%, about 0.4%, 0.15 to 0.35%, 0.150 to 0.300%, 0.10 to 0.35% or 1.0%;
f) nickel in the amount by weight percentage: 0%, 0 to 0.4%, about 0.4%, about 0.25% or about 0.30%;
g) chromium in the amount by weight percent: 0%, 0 to 5% (or to 6%), about 0.4%, 1.30 to 1.60%, 1.35 to 1.60%, 1.35 to 1.65%, 1.20 to 1.60% or 4.0 to 5.0% (or to 6%);
h) copper in the amount by weight percent: 0%, 0 to 0.30% or about 0.30%; or
i) molybdenum in the amount by weight percent: 0%, 0 to 0.65%, about 0.10% or 0.40 to 0.65%.

Ideally the whole balance of the weight percentage is then in iron.

Typically the iron content by weight is 93% to 98.98%, 98.51 to 98.98%, 96.5 to 97.32% or about 93%.

Percentages are wt %.

As for the base material, it is typically a titanium or titanium alloy, such as grade 2 Titanium. Other corrosion resistant alloys can also be used, onto which the above steel alloy is formed or fitted. This base material is primarily chosen for its corrosion and wear resistance.

The base material may be instead be one of the above disclosed steel alloys or hardened steel alloys. The surface may likewise be an alloy of steel and therefore the whole soldering tip may be formed of one of the steel alloys or hardened steel alloys discussed above. For example, the above steel alloys or hardened steel alloys may form the entirety of the soldering tip. Because they are metallophilic to solder such materials provide a wettable (commonly referred to as “tinned”) surface for the soldering tip, while having a significantly improved service life compared to conventional tips that have been tinned with solder, as well as a resistance to chemical or mechanical wear.

The whole soldering tip, however, should not be made of titanium or titanium alloys as titanium and most (if not all) titanium alloys are effectively metallophobic to solder. In other words, solder does not wet to it. This property contributes to titanium's excellent long term wear resistance when exposed to molten solder, but makes it unsuitable for the surface that needs to wet with the molten solder—optimum solder flow in a selective soldering application requires that the solder wet to the tip/nozzle. Only when wetted is a stable solder dome (bubble 12) at the top of soldering tip facilitated. Therefore, in the embodiment of FIG. 3, the steel alloy is used to coat or cover the base material. The steel alloy then instead facilitates the wetting of the tip by the molten solder.

Where needed, the coating or covering of the base material may be made or applied by any known method, but a particularly desirable approach is to use electrodeposition techniques, and one or more intermediate adhesion coating between it and the base material. Using an intermediate adhesion coating is beneficial as it can be chosen as a material that will adhere to the base material, and which is also compatible with receiving the steel alloy as a subsequent coating. This then facilitates a permanent bond of the steel alloy onto the base material. Trying to adhere silver steel onto titanium is otherwise very difficult.

More than one intermediate adhesion coating may be used, as that can offer a wider choice of materials for the outer coating. This facilitates the use of a wider range of steel alloys, as it enables materials to be chosen for the base and top coats even where there isn't a single suitable intermediate material choice that is compatible for adhesion to both.

With titanium and titanium alloys as the base material, getting even the intermediate adhesion coating to attach can be difficult. A preferred approach, therefore, is to use physical vapour deposition (PVD). This is a vacuum plasma deposition process that allows the deposition of various metals and ceramics onto a base material even where that base material is resistant to such coatings. The applied coatings using this approach will also tend to be hard and wear resistant, like the base material, as the properties of the coatings are affected by the substrate they are deposited on.

The intermediate coatings can be chosen to facilitate further electrodeposition of the steel alloy coating thereon, or a further intermediate coating, if required.

Through the use of PVD, the properties of the coatings can also be controlled. As indicated above, the properties of the coatings can be affected by the substrate they are deposited on. They can also be affected by the temperature of the ions reaching the substrate in relation to the melting point of the substrate (known as the homologous temperature) and the pressure of the gas flow in the chamber. These parameters affect the energy of the ions that assemble to form the coating. As these parameters can all be controlled, the use of PVD is particularly advantageous here.

The deposited coating will generally be electrically conductive to allow for other coatings (further intermediate adhesion layers or the final steel alloy coating) to be deposited thereon using electrodeposition, although electroless deposition is also possible instead.

Preferred materials for the adhesion coatings—particularly the first layer onto the base material—include tungsten carbide, titanium carbide and titanium nitride.

PVD is a line-of-sight process and as such it is difficult to use it to coat complex geometries. However, as shown in FIG. 3, the geometry of the soldering tip is straightforward—it is largely a frustoconical shape with an exposed and accessible outer shape. There are no overhangs or recesses to form surfaces to which a line of sight is not possible. Therefore, it is straightforward to use PVD for this purpose—it is simple to arrange the magnetron sputtering targets in the PVD coating system such that the outer surface of the base material can be selectively coated—for example, the apex circumference at the top of the base material and the slopped sides can be selectively coated, as shown in FIG. 3.

After the one or more adhesion coating is applied, the final “wettable” top layer coating can be applied. This is formed of the steel alloy, chosen to allow the soldering tip 10 to be wetted by molten solder 14. In the preferred embodiment this is deposited onto the adhesion later by electroplating.

The metals chosen for the steel alloy will be those that solder will wet to (requiring the solder to form a thin diffusion layer). A balance has to be struck between the solder forming a diffusion layer on it, and the solder dissolving the metal coating into the solder. >90% iron content steel alloys are commonly suitable for this purpose.

On conventional soldering tips, copper and tin have been known to be excellent choices for tinned surfaces as they are both easily wetted and already constituent elements of the solder itself. Therefore, even if dissolved into the solder, this is not introducing impurities into the solder flow. Gold and nickel have also been used in the prior art, but they are instead considered to be poor choices as gold will rapidly dissolve into the solder, and with enough gold the solder will become embrittled, whereas with nickel it will eventually saturate the solder causing tin-nickel intermetallic structures—commonly needles, to form. If not inhibited or filtered out, these intermetallic needles can become large and problematic in the folder flow—they are known to reach up to 10 mm in length, leading to severe degradation of the solder flow.

The inventors note that certain alloys of steel discussed above can provide excellent choices for the surfaces of the material as well as the body of the tip. They have properties which give good wetting properties and do not wear.

For the present invention the preferred steel alloy is instead silver steel, as discussed above. Other preferred steel alloys include C45 steel, EN31 steel and 501 stainless steel, as discussed above.

As per the embodiment of FIG. 3, and as discussed above, this may be deposited on the underlying base material via an intermediate adhesion layer. However, instead this may be a mechanically attached cap—e.g. one that encompasses the distal end and sidewalls of the soldering tip. A preferred alternative arrangement, however, is shown in FIG. 4, in which the steel alloy is instead fitted as an end piece 38 that is fitted into or onto a proximal body portion 40 of the soldering tip 10. In FIG. 4, this is achieved by way of an interference fit 48, although a screw-fit may instead be used.

In FIG. 4, therefore, the proximal body portion 40 has a screw connection 28 similar to that of the embodiment of FIG. 3, for connecting the soldering tip to the delivery tube 48 of the soldering apparatus 42, and a through-hole 16 extending therefrom to an upper (top) opening at the distal end 20 of the soldering tip 10. However, the material of the soldering tip 10 transitions between the proximal body portion 40 and the end piece 38, whereby the body portion 40 is made of the base material and the end piece 38 is made of the steel alloy—preferably silver steel.

That transition occurred in this embodiment through the provision of a recessed hole in the body portion's distal end and an interfacing annular hub extending out of the end piece 38 at its proximal end. The hub, bring fractionally larger than the hole allows an interference fit, whereby they can be pressed together to lock together. The coefficient of expansion of steel is typically higher than that of titanium whereby it is preferred that the steel alloy has the hub and the titanium has the hole, whereby the end piece will not come loose as it heats up to the temperature of the molten solder.

In FIG. 5, an embodiment of a soldering machine as disclosed in the current invention is shown below.

In FIG. 6, the mass difference (% change) of sample nozzles, corrected for mass gain due to solder deposits from the wettability of the nozzle, is given against time. The lower horizontal line represents a cut-off of nozzle lifetime (17% mass loss signifies a sufficient deterioration of the nozzle to render a risk of the bubble becoming inadequately stable for consistent soldering operations). The upper horizontal line is the starting mass—zero deterioration. As can be seen, the steel alloys having the characteristics of the present invention, i.e. silver steel, hardened silver steel, C45 steel, EN31 steel and 501 stainless steel, all exhibit markedly increased lifetimes over the AP average as they have a much slower deterioration rate (less steep line).

Silver steel, as one of the preferred materials for the steel alloy, has a standardised formulation in the United Kingdom and Europe, as set out in the table below, which table lists the minimum and maximum (and for the British Standard the typical) percentage (wt %) of the various elements within the steel alloy:

TABLE 1
Composition of Silver Steel

| | BS-1407 Silver Steel | | | DIN 1.2210/115CrV3 | |
|---|---|---|---|---|---|
| Element | Min | Typ | Max | Min | Max |
| Carbon | 0.95% | 1.13% | 1.25% | 1.10% | 1.25% |
| Chromium | 0.35% | 0.43% | 0.45% | 0.50% | 0.80% |
| Manganese | 0.25% | 0.37% | 0.45% | 0.20% | 0.40% |
| Silicon | 0 | 0.22% | 0.40% | 0.15% | 0.30% |
| Vanadium | | | | 0.07% | 0.12% |
| Phosphorus | 0 | 0.014% | 0.045% | 0 | 0.03% |
| Sulphur | 0 | 0.018% | 0.045% | 0 | 0.03% |

| | | |
|---|---|---|
| Iron | Balance | Balance |

C45 steel, as another one of the preferred materials for the steel alloy, has a standardised formulation in the United States, Europe and JAPAN as set out in Table 2 below, which table lists the minimum and maximum of the various elements within the steel alloy for complying with the Standards. However, the following more generic composition would also be desirable:

TABLE 2
Composition of C45 Steel according to various Standards

| Element | Content |
|---|---|
| Carbon, C | 0.420-0.50% |
| Iron, Fe | 98.51-98.98% |
| Manganese, Mn | 0.60-0.90% |
| Phosphorous, P | ≤0.040% |
| Sulfur, S | ≤0.050% |

| Standard | Grade | C | Mn | P | S | Si | Ni | Cr |
|---|---|---|---|---|---|---|---|---|
| ASTM | 1045 | 0.43- | 0.60- | 0.04 | 0.050 | | | |
| A29 | | 0.50 | 0.90 | | | | | |
| EN | C45/ | 0.42- | 0.50- | 0.03 | 0.035 | 0.4 | 0.4 | 0.4 |
| 10083-2 | 1.1191 | 0.50 | 0.80 | | | | | |
| JIS | S45C | 0.42- | 0.60- | 0.03 | 0.035 | 0.15- | | |
| G4051 | | 0.48 | 0.90 | | | 0.35 | | |

EN31 steel, as another one of the preferred materials for the steel alloy, has a standardised formulation in the United Kingdom and Europe, as set out in Table 3 below, which table lists the minimum and maximum (and for the British Standard the typical) percentage (wt %) of the various elements within the steel alloy for complying with the Standards. However, the following more generic composition would also be desirable:

TABLE 3
Composition of EN31 Steel

| | Element | | | Content (%) | | | | | | |
|---|---|---|---|---|---|---|---|---|---|---|
| | Iron, Fe | | | 96.5-97.32 | | | | | | |
| | Chromium, Cr | | | 1.30-1.60 | | | | | | |
| | Carbon, C | | | 0.980-1.10 | | | | | | |
| | Manganese, Mn | | | 0.250-0.450 | | | | | | |
| | Silicon, Si | | | 0.150-0.300 | | | | | | |
| | Sulfur, S | | | ≤0.0250 | | | | | | |
| | Phosphorus, P | | | ≤0.0250 | | | | | | |
| Standard | Grade | C | Mn | P | S | Si | Ni | Cr | Cu | Mo |
| ASTM | 52100 | 0.93- | 0.25- | 0.025 | 0.015 | 0.15- | 0.25 | 1.35- | 0.30 | 0.10 |
| A295 | | 1.05 | 0.45 | | | 0.35 | | 1.60 | | |
| DIN | 100Cr6/ | 0.90- | 0.25- | 0.030 | 0.025 | 0.15- | 0.30 | 1.35- | 0.30 | — |
| 17230 | 1.3505 | 1.05 | 0.45 | | | 0.35 | | 1.65 | | |
| JIS | SUJ2 | 0.95- | 0.5 | 0.025 | 0.025 | 0.15- | — | 1.30- | — | — |
| G4805 | | 1.10 | | | | 0.35 | | 1.60 | | |
| BS 970 | 535A99/ | 0.95- | 0.40- | — | — | 0.10- | — | 1.20- | — | — |
| | EN31 | 1.10 | 0.70 | | | 0.35 | | 1.60 | | |

501 stainless steel, as another one of the preferred materials for the steel alloy, has a standardised formulation in the United Kingdom and Europe, as set out in Table 4 below, which table lists the minimum and maximum (and for the British Standard the typical) percentage (wt %) of the various elements within the steel alloy for complying with the Standards:

TABLE 4
Composition of 501 stainless Steel

| Element | Content (%) |
|---|---|
| Iron, Fe | 93 |
| Chromium, Cr | 4.0-6.0 |
| Manganese, Mn | 1.0 |
| Silicon, Si | 1.0 |
| Molybdenum, Mo | 0.40-0.65 |
| Carbon, C | 0.10 |
| Phosphorus, P | 0.040 |
| Sulfur, S | 0.030 |

In some embodiments the steel alloy—either the coating, the cap or the end piece—can be additionally nitrided. For example, nitriding can be performed by a process known as gas nitriding. The process of gas nitriding can be performed on steel alloys, including silver steel, by, over a period of perhaps about 36 hours, placing the parts of steel alloy to be nitrided into a pressurised vessel which is substantially vacated of air, and circulating ammonia around the chamber at about 520° C., which ammonia diffuses into the surface creating a compound layer with a diffusion layer below. In some embodiments the compound layer is known as a white layer. Typically the steel alloy to be nitride in this manner is silver steel. However, it may be another form of steel alloy falling within the scope of the invention, such as those discussed above. By diffusing nitrogen into the surface (either in a large chamber pressure chamber or perhaps with a plasma process), it is possible to create an amount of nitride compounds up to certain depth in the material. This can harden the surface or reduce the surface corrosion from the solder, in effect slowing down any reaction the solder may have with the surface coating, or even the underlying base material or adhesion layer, if the surface coating is not a total covering for the underlying base material and adhesion layer.

For silver steel, the compound layer of the nitrided silver steel may have the following properties, as given in Table 5 below:

TABLE 5
Material Properties

| | Surface | Surface | Core | Core | Effective | | | |
|---|---|---|---|---|---|---|---|---|
| | hardness | hardness | hardness | hardness | Case | Total Case | | Compound |
| Material | Hv1 | (GPa) | Hv10 | (GPa) | Depth | Depth (visual) | | Layer |
| Silver | 351 | 3.442 | 224 | 2.197 | — | 0.510 mm | 0.560 mm- | 8 microns |
| Steel | | | | | | @ Core + | visual | |
| | | | | | | 50 Hv | | |

In some embodiments the steel alloy—either the coating, the cap or end piece—can be hardened. This can provide increased wear resistance and an increased service life to the soldering tips described in the present invention.

Various hardening processes that can be used are as follows:
1. The steel alloy, in some embodiments silver steel, can be hardened by the following steps. Firstly, the material is heated (usually slowly) to 760-800° C. The upper end of the temperature range is used for lower carbon containing steel alloys and the lower end of the temperature range is used for lower carbon containing steel alloys. Secondly, the material is allowed to austentized at least until the temperature is uniform. Finally, the material is then quenched into well agitated water to lock in the hardening process.
2. The steel alloy, in some embodiments C45 steel, can be hardened by the following steps. Firstly, the material is annealed by the material being heated to 800-850° C. until it is a uniform temperature in this range, before the material is then cooled in a furnace. Secondly, the material is normalised by heating the material to 870-920° C. until it is a uniform temperature in this range, before the material is soaked in water, brine or oil for 10-15 minutes and then cooled in (usually still) air. Thirdly, the material is stress-relieved by heating the material to 550-600° C. until it is a uniform temperature in this range, before the material is soaked in water, brine or oil for 1 hour per 25 mm of section and then cooled in (usually still) air. Fourthly, the material is hardened by heating the material to 820-850° C. until the temperature is uniform in this range, before the material is soaked in water, brine or oil for 10-15 minutes per 25 mm of section and then quenched in water or brine [or oil?]. Finally, the material is tempered: the material is reheated to a temperature in a range from 400 to 650° C., as required or desired, until the temperature is uniform in this range, before the material is then soaked in water, brine or oil for 1 hour per 25 mm of section and then cooled in (usually still) air.
3. The steel alloy, in some embodiments EN31 or AISI 52100 alloy steel, can be hardened by the following steps. The material is hardened by cold working, or heating and quenching steps. The material is then heated to 788° C. followed by quenching (for the second time if done previously). The material can then be carburized at 913° C. followed by further quenching.
4. The steel alloy, in some embodiments 501 stainless steel, can be hardened by the following steps. Firstly, the material can be given a full anneal by heating the material to 829 to 871° C. before gradual furnace cooling. Secondly, the material can be low annealed by heating the material to 718 to 746° C. followed by gradual cooling. Finally, the material can be hardened by heating it to 871 to 927° C., before then soaking, oil quenching and tempering at 204 to 760° C.
5. The above “nitriding” process.

The following table—Table 6—illustrates the changes in nozzle lifetime compared to a standard nozzle made of pure iron with a copper and tin plating, which demonstrates the advantageous benefits of the present invention's chosen material composition.

TABLE 6
Nozzle lifetime and percentage improvement

| | | Approx. time (hours) | Change in |
|---|---|---|---|
| | | to reach same mass | nozzle |
| | | loss as standard | lifetime |
| Substrate | Process | nozzle | (%) |
| Pure iron (99.8% | Cu and Sn plating | 213 | 100 |
| | (current coating) | | |
| Silver steel | N/A | 403 | 189 |
| Silver steel | Flame hardening | 660 | 310 |
| C45 | N/A | 639 | 300 |
| EN31 | N/A | 494 | 232 |
| 501 stainless steel | N/A | 865 | 406 |

In every case, the time taken to reach the same mass loss as a standard nozzle is significantly longer, and in most cases more than double or even as much as 4× as long.

The present invention therefore provides in preferred aspects a soldering tip for a soldering apparatus and a method of forming a soldering tip for a soldering apparatus, the tip comprising:
a body formed of a first material;
a proximal end for attaching the tip to the selective soldering apparatus; and
a distal end, the distal end having an outer surface, at least a region of which is formed from a second material, different to the first, the second material exhibiting greater solder wettability characteristics than the first material. The first material is preferably titanium or a titanium alloy and the region is preferably formed on the first material by first using a physical vapour deposition (PVD) process to create a first coating on at least a first part of the first material, which first part underlies the region, and then coating at least a part of that first coating with the second material.

The coatings may be complete or partial coatings—using PVD, for example, the underlying material may also still be visible through the coating.

The present invention has therefore been discussed above purely by way of example. Modifications in detail may be made to the invention within the scope of the claims as appended hereto.

1-42. (canceled)

43. A soldering nozzle through and/or over which molten solder can flow for soldering operations in a soldering apparatus, the nozzle comprising:
a body formed of a first material and having a proximal end for attaching the nozzle to the soldering apparatus; and
the nozzle also comprises an outer surface, at least a region of which is formed from a steel alloy, the steel alloy not exceeding 2 wt % carbon and 5 wt % chromium, and comprising:
0 wt % or 0 wt % to 0.1 wt % or 0.04 wt % to 0.65 wt % molybdenum;
0 wt % to 0.4 wt % nickel; and
0 wt % to 0.04 wt % phosphorous.

44. The soldering nozzle of claim 43, wherein the first material is also a steel alloy, and does not exceed 2 wt % carbon and 6 wt % chromium.

45. A soldering nozzle through and/or over which molten solder can flow for soldering operations in a soldering apparatus, the nozzle comprising:
a body having a proximal end for attaching the nozzle to the soldering apparatus; and
an outer surface, at least a region of which is formed from a steel alloy, the steel alloy not exceeding 2 wt % carbon and 6 wt % chromium, and comprising:
0 wt % or 0 wt % to 0.1 wt % or 0.04 wt % to 0.65 wt % molybdenum;
0 wt % to 0.4 wt % nickel; and
0 wt % to 0.04 wt % phosphorous.

46. The soldering nozzle of claim 45, wherein the or each steel alloy does not exceed 2% chromium.

47. The soldering nozzle of claim 45, wherein the iron content by weight of the or each steel alloy is at least 90%.

48. The soldering nozzle of claim 45, wherein the or each steel alloy has the following composition: 0.420 to 0.50% carbon, 0.60 to 0.90% manganese, 0 to 0.040% phosphorous, 0 to 0.050% sulphur and optionally contains 0 to 0.4% silicon, 0 to 0.4% chromium, and the whole balance in iron.

49. The soldering nozzle of claim 45, wherein the or each steel alloy has the following composition: 0.90 to 1.10% carbon, 0.25 to 0.70% manganese, 0 to 0.030% phosphorous, 0 to 0.025% sulphur, 0.10 to 0.35% silicon, 0 to 0.4% nickel, 1.2 to 1.65% chromium and optionally contains 0 to 0.3% nickel, 0 to 0.30% copper, 0 to 0.10% molybdenum, and the whole balance in iron.

50. The soldering nozzle of claim 45, wherein the or each steel alloy has the following composition: 0.10% carbon, 1.0% manganese, 0.040% phosphorous, 0.030% sulphur, 1.0% silicon, 4.0 to 6.0% chromium, 0.40 to 0.65% molybdenum, and the whole balance in iron.

51. The soldering nozzle of claim 45, wherein the or each steel alloy is nitrided.

52. The soldering nozzle of claim 45, wherein the soldering nozzle has a through-hole for solder to flow through it.

53. The soldering tip of claim 45, wherein the body has a threaded proximal end for attachment of the soldering tip to the soldering apparatus.

54. A method of manufacturing a soldering nozzle for a soldering apparatus, through and/or over which molten solder can flow for soldering operations in the soldering apparatus, the method comprising forming a soldering nozzle with a body having a proximal end for attaching the nozzle to the soldering apparatus and an outer surface, at least a region of the outer surface being formed from a steel alloy, the steel alloy not exceeding 2 wt % carbon and 6 wt % chromium, and comprising:
0 wt % or 0 wt % to 0.1 wt % or 0.04 wt % to 0.65 wt % molybdenum;
0 wt % to 0.4 wt % nickel; and
0 wt % to 0.04 wt % phosphorous; and
performing a hardening process thereto to harden at least a part of the surfaces thereof that will contact molten solder during use of the soldering nozzle.

55. The method of claim 54, wherein the hardening is by way of nitriding.

56. The method of claim 54, wherein the steel alloy is hardened by the following steps:
i) heating the soldering nozzle to 760-800° C.;
ii) allowing the soldering nozzle to austentize at least until the temperature is uniform; and
iii) quenching the soldering nozzle in water.

57. The method of claim 54, wherein the steel alloy is hardened by the following steps:
i) annealing the soldering nozzle by heating the soldering tip to 800-850° C.;
ii) cooling the soldering nozzle in a furnace;
iii) normalising the soldering nozzle by heating the soldering tip to 870-920° C.
iv) soaking the soldering nozzle in water, brine or oil for 10-15 minutes;
v) cooling the soldering nozzle in air;
vi) stress-relieving the soldering nozzle by heating the soldering tip to 550-600° C.;
vii) soaking the soldering nozzle in water, brine or oil for 1 hour per 25 mm of section;
viii) cooling the soldering nozzle in air;
ix) hardening the soldering nozzle by heating the soldering nozzle to 820-850° C.;
x) quenching and soaking the soldering nozzle in water, brine or oil for 10-15 minutes per 25 mm of section;
xi) tempering the soldering nozzle by reheating it to a temperature in a range from 400 to 650° C.;
xii) soaking the soldering nozzle in water, brine or oil for 1 hour per 25 mm of section; and
xiii) cooling the soldering nozzle in air.

58. The method of claim 54, wherein the steel alloy is hardened by the following steps:
i) hardening the soldering nozzle by cold working, or heating and quenching steps;
ii) heating the soldering nozzle to 788° C.;
iii) quenching the soldering nozzle;
iv) carburizing the soldering nozzle at 913° C.; and
v) further quenching the soldering nozzle.

59. The method of claim 54, wherein the steel alloy is hardened by the following steps:
i) annealing the soldering nozzle by heating the soldering nozzle to 829 to 871° C.;
ii) gradually furnace cooling the soldering nozzle;
iii) providing a further annealing step to the soldering nozzle by heating the soldering nozzle to 718 to 746° C.;
iv) gradually cooling the soldering nozzle;
v) hardening the soldering nozzle by heating it to 871 to 927° C.;
vi) soaking, oil quenching and then tempering at 204 to 760° C.

60. The soldering nozzle of claim 45, wherein the steel alloy comprises:
0.2 to 0.45% manganese;
0 to 0.4% silicon;
0 to 0.12% vanadium;
0 to 0.045% phosphorus;
0 to 0.045% sulphur; and
the balance in iron.

61. The soldering nozzle of claim 43, wherein the steel alloy comprises:
0.2 to 0.45% manganese;
0 to 0.4% silicon;
0 to 0.12% vanadium;
0 to 0.045% phosphorus;
0 to 0.045% sulphur; and
the balance in iron

62. The soldering nozzle of claim 43, wherein the first material is the same steel alloy as the region of the outer surface.
